(19) United States
(12) Patent Application Publication
(10) Pub. No.: US 2016/0350409 A1
(43) Pub. Date: Dec. 1, 2016

(54) ELECTRONIC DEVICE, INFORMATION PROVIDING SYSTEM AND INFORMATION PROVIDING METHOD THEREOF

(71) Applicant: Samsung Electronics Co., Ltd., Suwon-si (KR)

(72) Inventors: Sung Wan YOUN, Seoul (KR); Kyung Tae KIM, Hwaseong-si (KR); Sung Woon JANG, Hwaseong-si (KR); Sang Wook SHIN, Seoul (KR); Cheol Ho CHEONG, Seoul (KR); Sang Ki KANG, Suwon-si (KR); Chul Hwan LEE, Seoul (KR)

(21) Appl. No.: 15/168,781

(22) Filed: May 31, 2016

(30) Foreign Application Priority Data
May 28, 2015 (KR) 10-2015-0075272

(51) Int. Cl. G06F 17/30; H04M 1/725; H04W 4/18; H04L 12/58; H04W 8/18

(52) U.S. Cl. CPC G06F 17/30696; H04L 51/046; H04L 51/10; H04W 8/183; H04W 4/18; H04M 1/72552; G06F 17/30752

(57) ABSTRACT

An electronic device is provided. The electronic device includes a communication module that sends conversation information between users of the electronic device and an external electronic device to a management server if the conversation is obtained and receives a keyword extracted using the conversation information from the management server. The electronic device further includes a control module that controls to search for information using the keyword and send a portion of the found information to the external electronic device, and a display that displays the found information.

### CROSS-REFERENCE TO RELATED APPLICATION(S)

This application claims the benefit under 35 U.S.C. §119(a) of a Korean patent application filed on May 28, 2015 in the Korean Intellectual Property Office and assigned Serial number 10-2015-0075272, the entire disclosure of which is hereby incorporated by reference.

### TECHNICAL FIELD

The present disclosure relates to technology for providing specific information to a user who has a conversation with a counterpart.

### BACKGROUND

With the development of electronic technologies, various types of electronic devices are being developed and supplied. Electronic devices that have been being developed recently may become diverse in function, thus providing a user with various services such as an e-mail service, a web surfing service, a photographing service, an instant messing service, a scheduling service, a video reproduction service, an audio reproduction service, and the like. As various functions are applied to the electronic device, a situation in which two or more services are supported at the same time by one device may occur frequently.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device, an information providing system, and an information providing method capable of providing information to a user based on conversation content of a user in a situation where the user has a conversation with a specific counterpart using the electronic device.

In accordance with an aspect of the present disclosure, an electronic device is provided. The electronic device includes a communication module, a display, and a processor configured to obtain conversation information between users of the electronic device and an external electronic device, send the conversation information to a management server, receive a keyword, which is extracted based on the conversation information, from the management server, search for information based on the keyword, display the found information on the display, and send a portion of the found information to the external electronic device.

In accordance with another aspect of the present disclosure, an information providing method of an electronic device is provided. The information providing method includes obtaining conversation information between users of the electronic device and an external electronic device, sending the conversation information to a management server, receiving a keyword, which is extracted based on the conversation information, from the management server, searching for information based on the keyword, displaying the found information on a display, and sending a portion of the found information to the external electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a drawing illustrating a configuration of an information providing system according to various embodiments of the present disclosure;

FIG. 2 is a flowchart illustrating an information providing method of the information providing system according to various embodiments of the present disclosure;

FIG. 3 is a flowchart illustrating an information providing method of the information providing system according to various embodiments of the present disclosure;

FIG. 4 is a flowchart illustrating an information providing method of the information providing system according to various embodiments of the present disclosure;

FIG. 5 is a block diagram illustrating a configuration of a first electronic device according to various embodiments of the present disclosure;

FIG. 6 is a block diagram illustrating a configuration of the first electronic device according to various embodiments of the present disclosure;

FIG. 7 is a block diagram illustrating a configuration of the management server according to various embodiments of the present disclosure;

FIG. 8 is a flowchart illustrating an information providing method of the first electronic device according to various embodiments of the present disclosure; and

FIG. 9 is a flowchart illustrating an information providing method of the management server according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A and/or B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, “a first user device” and “a second user device” may indicate different user devices regardless of the order or priority thereof. For example, “a first user device” and “a second user device” indicate different user devices. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor (AP)) which performs corresponding operations by executing one or more software programs which are stored in a memory device.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device (e.g., a first electronic device, a second electronic device, or a peripheral electronic device) according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Moving Picture Experts Group Phase 1 or Phase 2 (MPEG-1 or MPEG-2) audio layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart mirrors, smart bands, smart watches, and the like.

According to some embodiments, the electronic devices may be smart home appliances. The smart home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles (e.g., Xbox™ and PlayStation™), electronic dictionaries, electronic keys, camcorders, electronic picture frames, and the like.

According to various embodiments, the electronic device may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices) receiving a user input in an idle mode, navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or Internet of Things (IoT) (e.g., light bulbs, various sensors, electric or gas meters, sprinkler devices, fire alarms, thermostats, street lamps, toasters, exercise equipment, hot water tanks, heaters, boilers, and the like).

According to an embodiment, the electronic devices may include at least one of parts of furniture or buildings/structures, electronic boards, electronic signature receiving devices, projectors, and/or various measuring instruments (e.g., water meters, electricity meters, gas meters, or wave meters, and the like). According to various embodiments, the electronic device may be one of the above-described devices or a combination thereof. An electronic device according to an embodiment may be a flexible electronic device. Furthermore, an electronic device according to an embodiment of the present disclosure may not be limited to the above-described electronic devices and may include other electronic devices and new electronic devices according to the development of technologies.

Hereinafter, electronic devices according to various embodiments will be described with reference to the accompanying drawings. The term “user” used herein may refer to a person who uses an electronic device or may refer to a device (e.g., an artificial electronic device) that uses an electronic device.

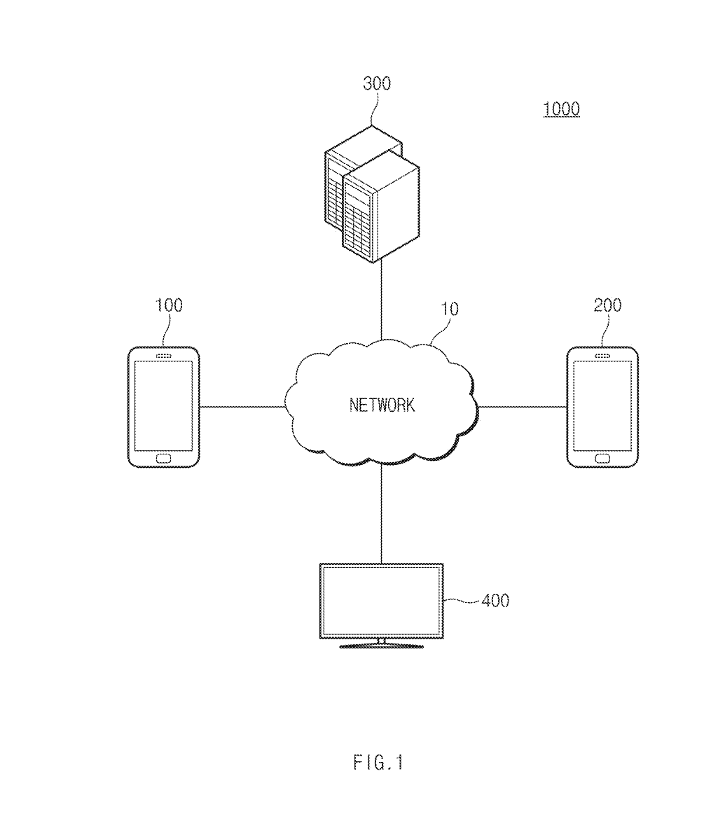

FIG. 1 is a drawing illustrating a configuration of an information providing system according to various embodiments of the present disclosure.

Referring to FIG. 1, the information providing system 1000 may include a first electronic device 100, a second electronic device 200, a management server 300, and a peripheral electronic device 400.

The first electronic device 100, the second electronic device 200, the management server 300, and the peripheral electronic device 400 may be connected to each other over a network 10 so as to communicate with one another. For example, the first electronic device 100, the second electronic device 200, the management server 300, and the peripheral electronic device 400 may be connected to each other over an Internet network or mobile communication network.

Users of the first electronic device 100 and the second electronic device 200 may have a conversation with each other over the network 10. For example, the users of the first electronic device 100 and the second electronic device 200 may make a voice call, a video call, or a text conversation using a messaging application. The first electronic device 100 may obtain conversation information of the users of the first and second electronic devices 100 and 200 and may send the obtained conversation information to the management server 300 or the peripheral electronic device 400. According to an embodiment, the conversation information may include conversation content between the users of the first electronic device 100 and the second electronic device 200. According to an embodiment, the conversation information may include conversation content and participant identification information. According to an embodiment, the conversion content may include at least one of a voice and/or a text. The participant identification information that is information for identifying the users of the first electronic device 100 and the second electronic device 200 may include, for example, at least one of a phone number, an image, a service identifier (ID) (e.g., a messaging application ID or a social network service (SNS) ID), and/or an e-mail address. According to an embodiment, the first electronic device 100 and the second electronic device 200 may share the participant identification information with each other.

According to an embodiment, if a keyword that is extracted by the management server 300 based on the conversation information is received, the first electronic device 100 may search for keyword-related information based on the keyword. For example, the first electronic device 100 may search for photos, videos, music, goods, news, weather, and the like that are associated with the keyword. According to an embodiment, the keyword-related information may be found from at least one of a web server (not shown) and/or a cloud server (not shown) that a user utilizes. The web server may include, for example, a server that provides an Internet web page and a server that provides services by using SNS applications, game applications, and the like. According to an embodiment, the first electronic device 100 may search for information stored therein.

According to an embodiment, the first electronic device 100 may output the found information that is found by itself and is received from the management server 300 or the peripheral electronic device 400. For example, the first electronic device 100 may display the found information of an image or text form on a display or may output the found information of an audio form by using a speaker. According to an embodiment, the first electronic device 100 may display public information and private information on different areas of the display, respectively. According to an embodiment, the first electronic device 100 may send the found information to the peripheral electronic device 400 to allow the peripheral electronic device 400 to output the found information.

According to an embodiment, the first electronic device 100 may perform a search operation by itself or may send a portion of the found information received from the management server 300 to the second electronic device 200. According to an embodiment, the first electronic device 100 may send information, which is found from the web server, of the found information to the second electronic device 200. According to an embodiment, the first electronic device 100 may determine whether the found information is public information or private information and may send the public information of the found information to the second electronic device 200 based on the determination result. According to an embodiment, the first electronic device 100 may determine whether information that is found based on identification information of a user of the second electronic device 200 is information associated with the user of the second electronic device 200 and may send information, which is associated with the user of the second electronic device 200, of the found information to the second electronic device 200 based on the determination result.

If receiving a portion of the found information from the first electronic device 100, the second electronic device 200 may output the received found information. For example, the second electronic device 200 may display the found information of an image or text form on the display or may output the found information of an audio form by using the speaker.

The management server 300 may extract a keyword by processing conversation information that is received through the first electronic device 100 or through the peripheral electronic device 400 from the first electronic device 100. According to an embodiment, if conversation content of a voice form is received, the management server 300 may convert the conversation content from the voice form into a text form and may extract a keyword from the conversation content of the text form. According to an embodiment, the keyword that corresponds to a result of analyzing the conversation information may not be a portion of the conversation content. Alternatively, the keyword may be information induced from metadata or the conversation information. According to an embodiment, the management server 300 may send the keyword to the first electronic device 100 or the peripheral electronic device 400.

According to an embodiment, the management server 300 may search for keyword-related information based on the keyword. According to an embodiment, the management server 300 may search for the keyword-related information from at least one of a web server (not shown) and/or a cloud server (not shown) that a user utilizes. In the case where the management server 300 needs rights to access the web server or cloud server, the management server 300 may request necessary information (e.g., an account ID and a password) from the first electronic device 100 and may receive the necessary information therefrom. According to an embodiment, in the case where an operation of searching for the keyword-related information from the web server and cloud server is performed at the first electronic device 100, an information search operation of the management server 300 may be omitted.

According to an embodiment, the management server 300 may send the found information to the first electronic device 100 or the peripheral electronic device 400. According to an embodiment, if an instruction for designating the peripheral electronic device 400 as a device that will receive the found information is received from the first electronic device 100, the management server 300 may send the found information to the peripheral electronic device 400.

The peripheral electronic device 400 may mean an electronic device that exists within a specific range from the first electronic device 100. For example, in the case where the first electronic device 100 exists in a house of a user thereof, a TV, a desktop PC, or the like in the living room may be the peripheral electronic device 400. The first electronic device 100 and the peripheral electronic device 400 may be connected using near field wireless communication technologies such as a wired/wireless home network, Bluetooth, wireless friendly (Wi-Fi), and the like.

According to an embodiment, the peripheral electronic device 400 may receive found information from the first electronic device 100 or the management server 300. According to an embodiment, the peripheral electronic device 400 may output the received found information. For example, the peripheral electronic device 400 may display the found information of an image or text form on the display or may output the found information of an audio form by using the speaker. Accordingly, the user of the first electronic device 100 may be provided with a result of searching for the content of conversation with the user of the second electronic device 200 through the peripheral electronic device 400 around the user of the first electronic device 100.

According to an embodiment, if conversation information is received from the first electronic device 100, the peripheral electronic device 400 may send the received conversation information to a server. If a keyword extracted based on the conversation information is received from the management server 300, the peripheral electronic device 400 may search for keyword-related information based on the keyword. According to an embodiment, the peripheral electronic device 400 may search for the keyword-related information from at least one of a web server (not shown) and/or a cloud server (not shown) that a user utilizes. In the case where the management server 300 needs rights to access the web server or cloud server, the management server 300 may request necessary information (e.g., an account ID and a password) from the first electronic device 100 and may receive the necessary information therefrom. According to an embodiment, the peripheral electronic device 400 may output the found information.

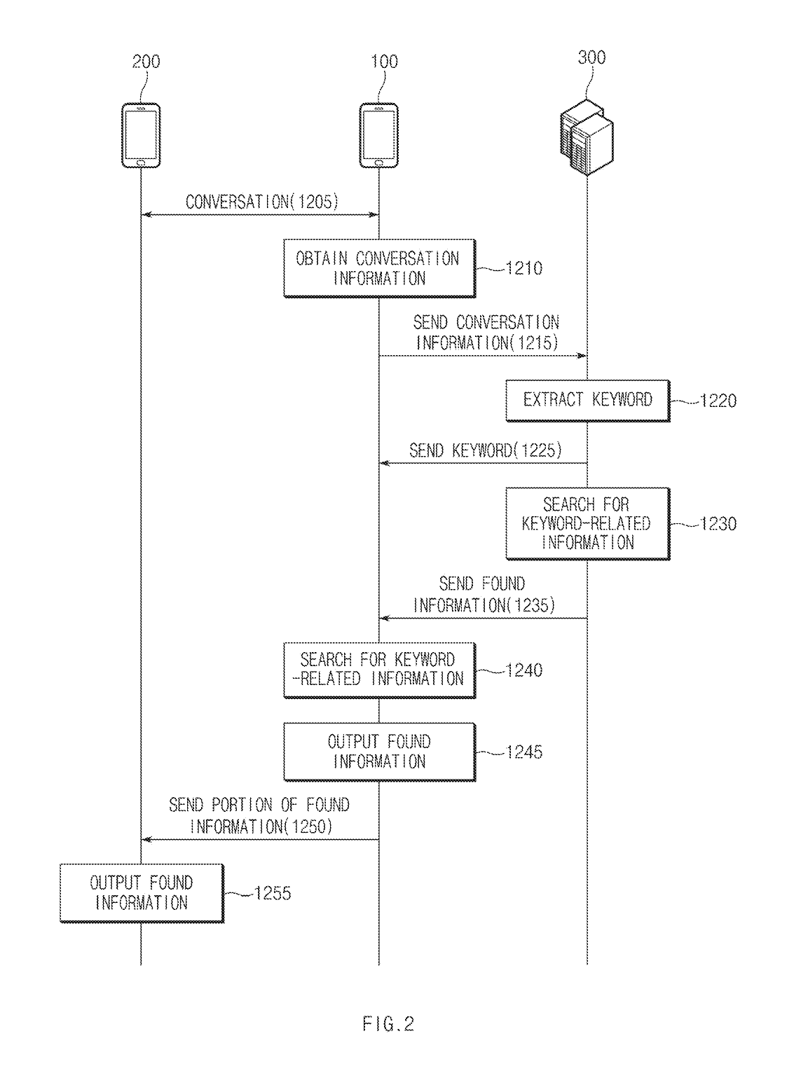

FIG. 2 is a flowchart illustrating an information providing method of the information providing system according to various embodiments of the present disclosure.

Referring to FIG. 2, in operation 1205, users of the first electronic device 100 and the second electronic device 200 may have a conversation with each other. For example, the first electronic device 100 may send a voice or text input by the user thereof to the second electronic device 200 and may output a counterpart voice or a text, corresponding to the counterpart voice, received from the second electronic device 200. In addition, the second electronic device 200 may send a voice or text input by the user thereof to the first electronic device 100 and may output a counterpart voice or a text, corresponding to the counterpart voice, received from the first electronic device 100.

In operation 1210, the first electronic device 100 may obtain conversation information. According to an embodiment, the conversation information may include conversation content between the users of the first electronic device 100 and the second electronic device 200. According to an embodiment, the conversation information may include conversation content and participant identification information. According to an embodiment, the conversion content may include at least one of a voice and/or a text. The participant identification information that is information for identifying the users of the first electronic device 100 and the second electronic device 200 may include, for example, at least one of a phone number, an image, a service ID (e.g., a messaging application ID or an SNS ID), and/or an e-mail address.

In operation 1215, the first electronic device 100 may send the conversation information to the management server 300.

The management server 300 may extract a keyword by processing the conversation information received from the first electronic device 100. According to an embodiment, if conversation content of a voice form is received, the management server 300 may convert the conversation content from the voice form into a text form and may extract a keyword from the conversation content of the text form.

In operation 1225, the management server 300 may send the extracted keyword to the first electronic device 100.

In operation 1230, the management server 300 may search for keyword-related information based on the keyword. According to an embodiment, the management server 300 may search for the keyword-related information from at least one of a web server (not shown) and/or a cloud server (not shown) that a user utilizes.

In operation 1235, the management server 300 may send the found information to the first electronic device 100.

In operation 1240, the first electronic device 100 may search for the keyword-related information based on the keyword received from the management server 300. According to an embodiment, the first electronic device 100 may search for the keyword-related information from at least one of a web server (not shown) and/or a cloud server (not shown) that a user utilizes. According to an embodiment, the first electronic device 100 may search for information stored in a memory.

In operation 1245, the first electronic device 100 may output the found information. According to an embodiment, the first electronic device 100 may output information that is found by itself and is received from the management server 300 or the peripheral electronic device 400. For example, the first electronic device 100 may display the found information of an image or text form on a display. According to an embodiment, the first electronic device 100 may determine whether the found information is public information or private information. According to an embodiment, the first electronic device 100 may display pieces of the public and private information on different areas of the display, respectively.

In operation 1250, the first electronic device 100 may send a portion of the found information. According to an embodiment, the first electronic device 100 may send information, which is found from the web server, of the found information to the second electronic device 200. According to an embodiment, the first electronic device 100 may determine whether the found information is public information or private information and may send the public information of the found information to the second electronic device 200 based on the determination result. According to an embodiment, the first electronic device 100 may determine whether information that is found using identification information of a user of the second electronic device 200 is information associated with the user of the second electronic device 200 and may send information, which is associated with the user of the second electronic device 200, of the found information to the second electronic device 200 based on the determination result.

In operation 1255, the second electronic device 200 may output the found information received from the first electronic device 100.

According to an embodiment described with reference to FIG. 2, the user of the second electronic device 200 may be provided with information, which is associated with conversation content, of the private information of the user of the first electronic device 100.

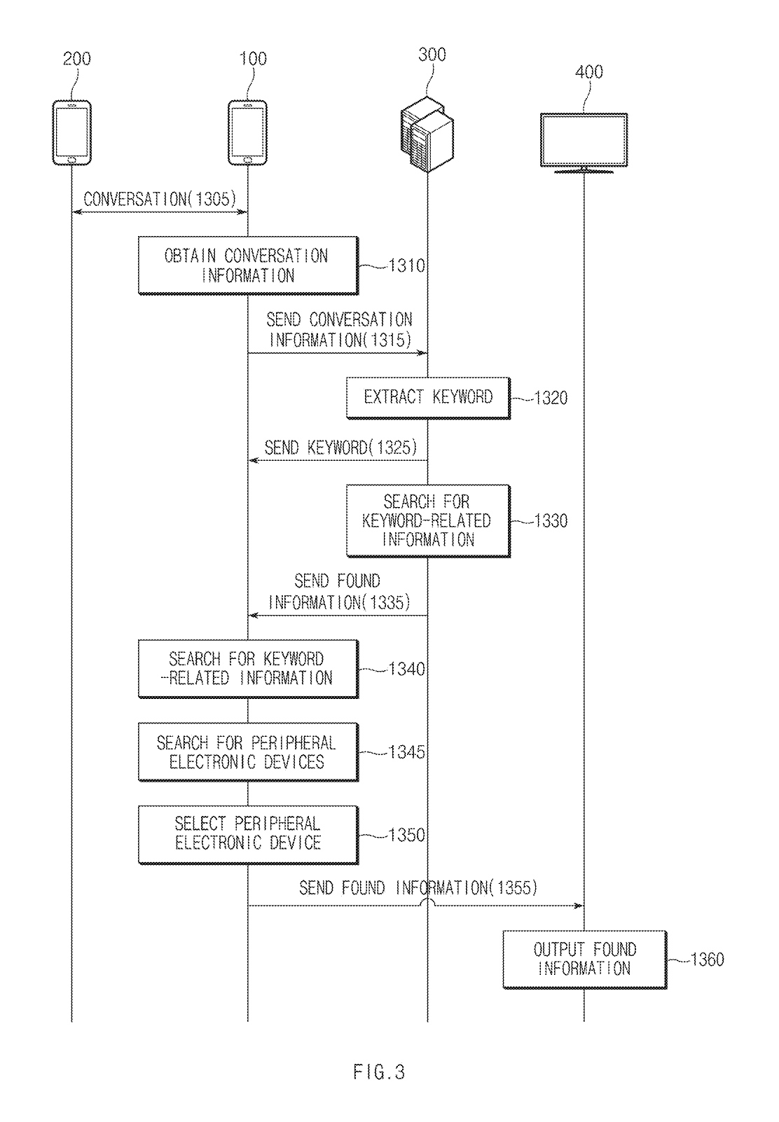

FIG. 3 is a flowchart illustrating an information providing method of the information providing system according to various embodiments of the present disclosure.

Referring to FIG. 3, in operation 1305, users of the first electronic device 100 and the second electronic device 200 may have a conversation with each other. For example, the first electronic device 100 may send a voice or text input by the user thereof to the second electronic device 200 and may output a counterpart voice or a text, corresponding to the counterpart voice, received from the second electronic device 200. In addition, the second electronic device 200 may send a voice or text input by the user thereof to the first electronic device 100 and may output a counterpart voice or a text, corresponding to the counterpart voice, received from the first electronic device 100.

In operation 1310, the first electronic device 100 may obtain conversation information. According to an embodiment, the conversation information may include conversation content between the users of the first electronic device 100 and the second electronic device 200. According to an embodiment, the conversation information may include conversation content and participant identification information. According to an embodiment, the conversion content may include at least one of a voice and/or a text. The participant identification information that is information for identifying the users of the first electronic device 100 and the second electronic device 200 may include, for example, at least one of a phone number, an image, a service ID (e.g., a messaging application ID or an SNS ID), and/or an e-mail address.

In operation 1315, the first electronic device 100 may send the conversation information to the management server 300.

In operation 1320, the management server 300 may extract a keyword by processing the conversation information received from the first electronic device 100. According to an embodiment, if conversation content of a voice form is received, the management server 300 may convert the conversation content from the voice form into a text form and may extract a keyword from the conversation content of the text form.

In operation 1325, the management server 300 may send the extracted keyword to the first electronic device 100.

In operation 1330, the management server 300 may search for keyword-related information based on the keyword. According to an embodiment, the management server 300 may search for the keyword-related information from at least one of a web server (not shown) and/or a cloud server (not shown) that a user utilizes.

In operation 1335, the management server 300 may send the found information to the first electronic device 100.

In operation 1340, the first electronic device 100 may search for the keyword-related information based on the keyword received from the management server 300. According to an embodiment, the first electronic device 100 may search for the keyword-related information from at least one of a web server (not shown) and/or a cloud server (not shown) that a user utilizes. According to an embodiment, the first electronic device 100 may search for information stored therein.

In operation 1345, the first electronic device 100 may search for peripheral electronic devices 400.

In operation 1350, the first electronic device 100 may select at least one of the found peripheral electronic devices 400. According to an embodiment, the first electronic device 100 may receive device profiles from the found peripheral electronic devices 400 and may select at least one of the found peripheral electronic devices 400 based on the device profiles. The device profile may include, for example, identification information, a location, owner information, input/output sources, and the like of the peripheral electronic device 400.

In operation 1355, the first electronic device 200 may send the found information to the selected peripheral electronic device 400. According to an embodiment, if a plurality of peripheral electronic devices 400 are selected, the first electronic device 100 may send pieces of different found information to the plurality of peripheral electronic devices 400, respectively. According to an embodiment, if a plurality of peripheral electronic devices 400 are selected, the first electronic device 100 may send pieces of found information of different forms to the plurality of peripheral electronic devices 400, respectively. For example, if a TV and a tablet PC are selected as peripheral electronic devices 400, it may be possible to send the found information of an image or video form to the TV and the found information of a text form to the tablet PC.

In operation 1360, the peripheral electronic device 400 may output the found information received from the first electronic device 100.

According to an embodiment described with reference to FIG. 3, in the case where the peripheral electronic device 400 that provides information more effectively than the first electronic device 100 exists, the user of the first electronic device 100 may be provided with a variety of information associated with conversation content through the peripheral electronic device 400.

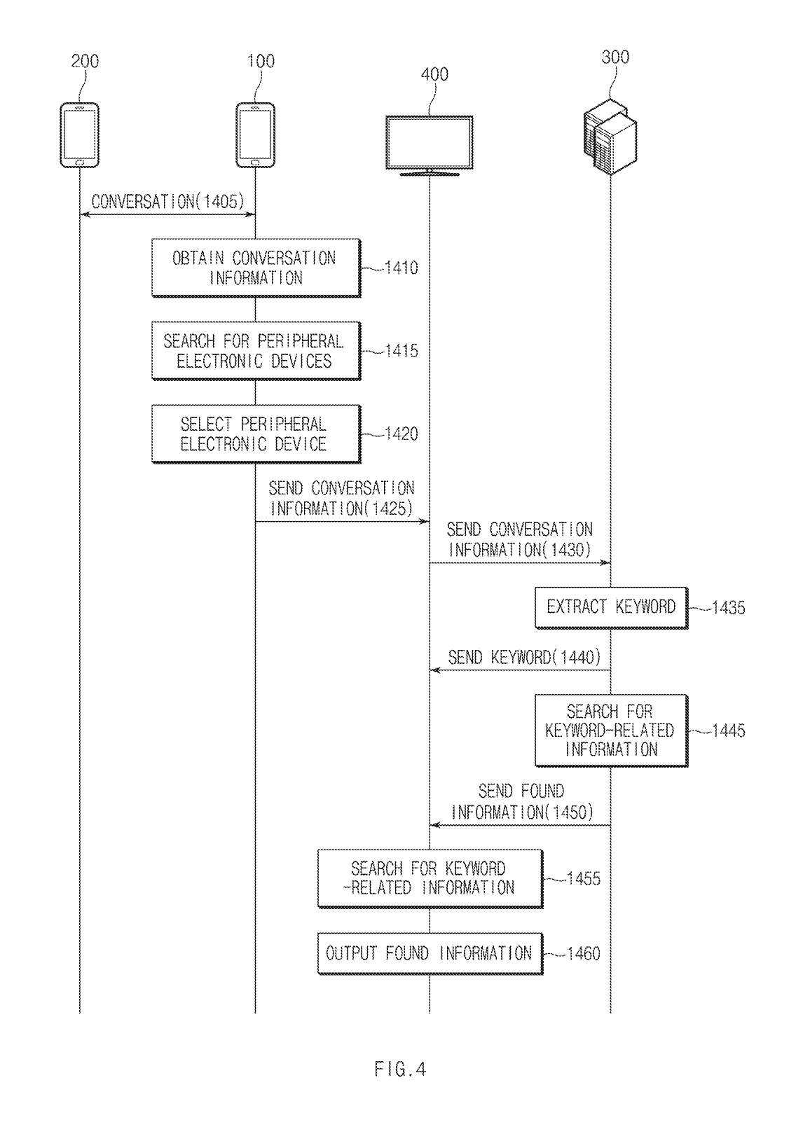

FIG. 4 is a flowchart illustrating an information providing method of the information providing system according to various embodiments of the present disclosure.

Referring to FIG. 4, in operation 1405, users of the first electronic device 100 and the second electronic device 200 may have a conversation with each other. For example, the first electronic device 100 may send a voice or text input by the user thereof to the second electronic device 200 and may output a counterpart voice or a text, corresponding to the counterpart voice, received from the second electronic device 200. In addition, the second electronic device 200 may send a voice or text input by the user thereof to the first electronic device 100 and may output a counterpart voice or a text, corresponding to the counterpart voice, received from the first electronic device 100.

In operation 1410, the first electronic device 100 may obtain conversation information. According to an embodiment, the conversation information may include conversation content between the users of the first electronic device 100 and the second electronic device 200. According to an embodiment, the conversation information may include conversation content and participant identification information. According to an embodiment, the conversion content may include at least one of a voice and/or a text. The participant identification information that is information for identifying the users of the first electronic device 100 and the second electronic device 200 may include, for example, at least one of a phone number, an image, a service ID (e.g., a messaging application ID or an SNS ID), and/or an e-mail address.

In operation 1415, the first electronic device 100 may search for peripheral electronic devices 400.

In operation 1420, the first electronic device 100 may select at least one of the found peripheral electronic devices 400. According to an embodiment, the first electronic device 100 may receive device profiles from the found peripheral electronic devices 400 and may select at least one of the found peripheral electronic devices 400 based on the device profiles. The device profile may include, for example, identification information, a location, owner information, input/output sources, and the like of the peripheral electronic device 400.

In operation 1425, the first electronic device 100 may send conversation information to the selected peripheral electronic device 400.

In operation 1430, the peripheral electronic device 400 may send the conversation information to the management server 300.

In operation 1435, the management server 300 may extract a keyword by processing the conversation information received from the peripheral electronic device 400. According to an embodiment, if conversation content of a voice form is received, the management server 300 may convert the conversation content from the voice form into a text form and may extract a keyword from the conversation content of the text form.

In operation 1440, the management server 300 may send the extracted keyword to the peripheral electronic device 400.

In operation 1445, the management server 300 may search for keyword-related information based on the keyword. According to an embodiment, the management server 300 may search for the keyword-related information from at least one of a web server (not shown) and/or a cloud server (not shown) that a user utilizes.

In operation 1450, the management server 300 may send the found information to the peripheral electronic device 400.

In operation 1455, the peripheral electronic device 400 may search for the keyword-related information based on the keyword received from the management server 300. According to an embodiment, the peripheral electronic device 400 may search for the keyword-related information from at least one of a web server (not shown) and/or a cloud server (not shown) that a user utilizes. For example, the peripheral electronic device 400 may request and receive the keyword-related information from the first electronic device 100.

In operation 1460, the peripheral electronic device 400 may output the found information.

According to an embodiment described with reference to FIG. 3, in the case where the peripheral electronic device 400 that provides information more effectively than the first electronic device 100 exists, the user of the first electronic device 100 may be provided with a variety of information associated with conversation content through the peripheral electronic device 400.

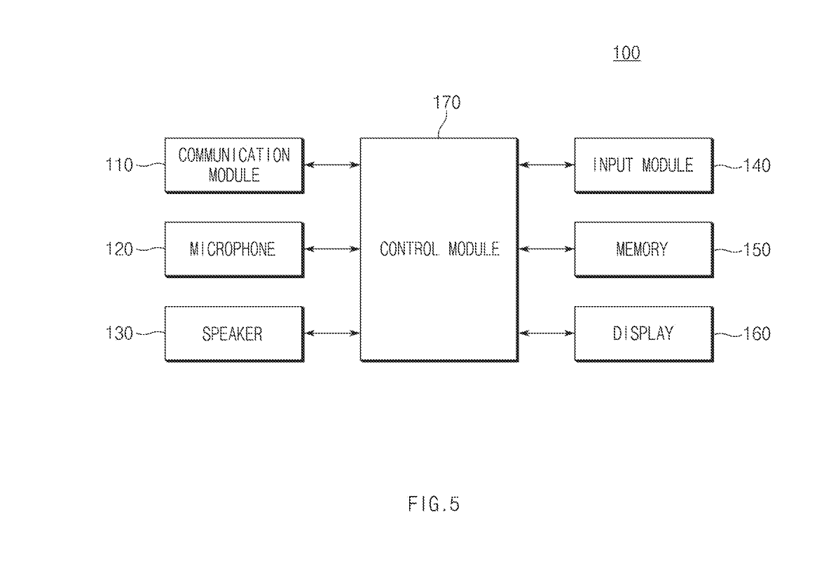

FIG. 5 is a block diagram illustrating a configuration of the first electronic device according to various embodiments of the present disclosure.

Referring to FIG. 5, the first electronic device 100 may include a communication module 110, a microphone 120, a speaker 130, an input module 140, a memory 150, a display 160, and a control module 170.

The communication module 110 may communicate with the second electronic device 200, the management server 300, or the peripheral electronic device 400 over the network 10. For example, the communication module 110 may be connected with the second electronic device 200, the management server 300, and the peripheral electronic device 400 over an Internet network or mobile communication network. As another example, the communication module 110 may be connected with the peripheral electronic device 400 by using near field wireless communication technologies such as a wired/wireless home network, Bluetooth, Wi-Fi, and the like.

According to an embodiment, the communication module 110 may send conversation content of a user of the first electronic device to the second electronic device 200 and may receive conversation content of a counterpart from the second electronic device 200.

According to an embodiment, the communication module 110 may send at least a portion of found information to the second electronic device 200. According to an embodiment, the communication module 110 may send the found information through a communication channel that is different from a communication channel for sending and receiving conversation content to and from the second electronic device 200.

According to an embodiment, the communication module 110 may receive identification information of a conversation counterpart from the second electronic device 200. For example, the communication module 110 may receive at least one of a phone number, an image, a service ID, and/or an e-mail address of the conversation counterpart (e.g., a user of the second electronic device 200) from the second electronic device 200.

According to an embodiment, the communication module 110 may send conversation information to the management server 300 or the peripheral electronic device 400. The conversation information may include, for example, conversation content and participant identification information. According to an embodiment, the communication module 110 may receive a keyword, which is extracted based on the conversation information, from the management server 300 or the peripheral electronic device 400. A keyword of a text form may be received from the management server 300.

According to an embodiment, the communication module 110 may receive found information from the management server 300 or the peripheral electronic device 400. According to an embodiment, the found information that is received from the management server 300 or the peripheral electronic device 400 may be information that is found from a web server (not shown) or a cloud server (not shown) that a user utilizes.

The microphone 120 may receive a voice of a user and may convert the received voice into an audio signal. For example, the microphone 120 may receive conversation content of a voice form from the user.

The speaker 130 may convert and output the audio signal into sound. For example, the speaker 130 may output a counterpart voice received from the second electronic device 200. According to an embodiment, the speaker 130 may output the found information of an audio form.

The input module 140 may receive a manipulation of the user. For example, the input module 140 may receive conversation content of a text form from the user. According to various embodiments, the input module 140 may include at least one of a touch screen or touch pad operating by a touch input of a user, a pen sensor operating by a pen input of the user, a keypad, and/or a motion recognition sensor recognizing motion of the user.

For example, the memory 150 may store information. For example, the memory 150 may store photos, images, videos, audio, documents, e-mails, schedules, memos, contact, a call history, travel information, purchasing/payment information, application use information, and the like that a user takes or records or that the user downloads from a web server. According to an embodiment, the memory 150 may store identification information of a user or conversation counterpart. For example, the memory 150 may store at least one of a name, a phone number, an image, a service ID, or an e-mail address of the user and/or conversation counterpart.

The display 160 may display the found information. For example, the display 160 may display information found by the control module 170 or found information received from the management server 300.

The control module 170 may control each of the communication module 110, the microphone 120, the speaker 130, the input module 140, the memory 150, and the display 160 to provide the found information to a user according to various embodiments of the prevent disclosure. According to an embodiment, the control module 170 (or, a processor) (e.g., an AP) may be implemented with a system on chip (SoC) that includes a CPU, a graphics processing unit (GPU), a video processor, a memory, and the like.

According to an embodiment, the control module 170 may classify conversation content of the user and conversation counterpart. For example, the control module 170 may determine conversation content of a voice or text form, which is input through the microphone 120 or the input module 140, as user conversation content and may determine conversation content of a voice or text form, which is received from the second electronic device 200, as counterpart conversation content. According to an embodiment, the control module 170 may classify pieces of conversation content into the conversation content of the user and the conversation content of the counterpart, sending the conversation content thus classified to the management server 300 or the peripheral electronic device 400. According to an embodiment, the participant identification information may be used to distinguish between the conversation content of the user and conversation content of the counterpart. For example, the conversation content of the user and conversation content of the counterpart may be sent to the management server 300 or the peripheral electronic device 400 based on data organization of the following Table 1.

TABLE 1
[0000][voice] “user conversation content #1” [0001][voice]
“counterpart conversation content #1”
[0000][text] “user conversation content #2” [0001][voice] “counterpart
conversation content #2” ...

In Table 1, for example, [0000] and [0001] may correspond to user identification information and participant identification information, respectively, and each of [voice] and [text] may be metadata indicating a kind of conversation content (e.g., voice data or text data).

According to an embodiment, the control module 170 may search for keyword-related information based on a keyword received from the management server 300 or the peripheral electronic device 400. According to an embodiment, the control module 170 may search for the keyword-related information from at least one of the memory 150, a web server (not shown), and/or a cloud server (not shown) that a user utilizes. For example, in the case where a keyword is “summer and Mt. Seolark”, the control module 170 may search for photos and videos, which a user takes during the summer vacation, from the memory 150 or the cloud server. Furthermore, the control module 150 may search for Seolark photos in summer, weather, means for transportation for Mt. Seolark from a current location of a user, a time, and the like, from the web server 150.

According to an embodiment, the control module 170 may determine whether the found information is information associated with a conversation counterpart. According to an embodiment, the control module 170 may determine whether the found information is information associated with the conversation counterpart, by comparing metadata, tag information, and the like of the found information with identification information of the conversation counterpart (e.g., a user of the second electronic device 200). For example, if a counterpart name is included in tag information of the found photo or video, the control module 170 may determine the found information as being information associated with the conversation counterpart. As another example, the control module 170 may perform face recognition with respect to the found photo or video. If the face recognition result indicates that a counterpart's face is included in the found photo or video, the control module 170 may determine the found information as being information associated with the conversation counterpart. As another example, in the case where the found information is information found using a SNS account of a user and includes a thing that the counterpart recommends or comments, the control module 170 may determine the found information as being information associated with the conversation counterpart.

According to an embodiment, the first electronic device 400 may determine whether the found information (e.g., information that a user of the first electronic device 100 searches for or found information received from the management server 300 or the peripheral electronic device 400) is public information or private information. According to an embodiment, the control module 170 may determine whether the found information is public information or private information, based on a source of the found information. For example, if a source of the found information is a web server, the control module 170 may determine the found information as being the public information. If a source of the found information is the memory 150 or the cloud server, the control module 170 may determine the found information as being the private information. As another example, in the case where the found information is revealed on SNS, the control module 170 may determine the found information as being public information. According to an embodiment, the control module 170 may determine whether the found information is public information or private information, based on rights to access the found information. For example, the control module 170 may determine information, which requires account information or a password in a search process, as being private information and may determine information, which is accessible without a condition, as being public information. According to an embodiment, the control module 170 may determine whether the found information is public information or private information, based on a kind of the found information. For example, the control module 170 may determine a contact, a schedule, an e-mail, etc. as being private information and may determine news, weather information, etc. as being public information.

According to an embodiment, the control module 170 may display the found information on the display 160. According to an embodiment, the control module 170 may select information, which is to be displayed on the display 160, of the found information and may display only the selected information on the display 160. According to an embodiment, the control module 170 may display pieces of public and private information of the found information in different areas of the display 160, respectively. According to an embodiment, the control module 170 may display information found from the first electronic device (e.g., a memory) or cloud server and information found from a web server on different areas of the display 160.

According to an embodiment, the control module 170 may send a portion of the found information to the second electronic device 200 through the communication module 110. According to an embodiment, the control module 170 may send public information of the found information to the second electronic device 200 through the communication module 110. According to an embodiment, the control module 170 may send information, which is found from a web server, of the found information to the second electronic device 200 through the communication module 110. According to an embodiment, the control module 170 may send information associated with a conversation counterpart (e.g., a user of the second electronic device 200) to the second electronic device 200 through the communication module 110.

The control module 170 may convert the found information to be sent to the second electronic device 200 into information of a form that is suitable for the second electronic device 200 to receive. Here, the converted information may be sent to the second electronic device 200. The control module 170 may convert the found information to be sent to the second electronic device 200 into information of a form that is suitable for the second electronic device 200 to receive based on a communication channel that the second electronic device 200 can use. Here, the converted information may be sent to the second electronic device 200. For example, in the case where the second electronic device 200 cannot use a data communication channel and makes a call using a 3^{rd} generation (3G) voice channel, the second electronic device 200 cannot receive found information of a video or text form using the 3G voice channel. For this reason, the first electronic device 100 may convert the found information into information of a form that is suitable for the second electronic device 200 to receive and may send the converted information to the second electronic device 200. As another example, the first electronic device 100 may convert the found information from a video or voice form to a text form and may transmit the found information of the text form to the outside using a short messaging service (SMS) communication channel. According to an embodiment, when sending content over a channel (e.g., an SMS communication channel) different from the communication channel, the control module 170 may make it possible to send a voice message providing notification that content is sent to a counterpart using a voice communication channel. According to an embodiment, in the case where the second electronic device 200 does not support an information providing service (e.g., an application for the information providing service is not installed on the second electronic device 200), the control module 170 may convert the found information into information of a form that is suitable for the second electronic device 200 to receive and may send the converted information to the second electronic device 200. For example, in the case where an application is not installed on the second electronic device 200, the first electronic device 100 may convert found information into information of a form that is suitable for the second electronic device 100 to receive through a call channel and may send the converted information to the second electronic device 200. As another example, the first electronic device 100 may convert found information from a video or voice form to a text form and may transmit the found information of the text form to the outside using an SMS communication channel.

According to an embodiment, the control module 170 may search for peripheral electronic devices that exist within a specific range. According to an embodiment, the control module 170 may search for the peripheral electronic device 400 that is capable of communicating with the first electronic device 100. For example, the control module 170 may control the control module 110 to send a signal (e.g., a beacon signal or a probe signal) for searching for the peripheral electronic device 400 and receive a response from the peripheral electronic device 400. According to an embodiment, the control module 170 may select at least one of the found peripheral electronic devices 400. For example, the control module 170 may receive device profiles from the found peripheral electronic devices 400 and may select at least one of the found peripheral electronic devices 400 based on the device profiles. The device profile may include, for example, identification information, a location, owner information, input/output sources, and the like of the peripheral electronic device 400.

The control module 170 may control the control module 110 to send the found information to the selected peripheral electronic device 400. According to an embodiment, if a plurality of peripheral electronic devices 400 are selected, the first electronic device 100 may send pieces of different found information to the plurality of peripheral electronic devices 400, respectively. According to an embodiment, if a plurality of peripheral electronic devices 400 are selected, the first electronic device 100 may send pieces of found information of different forms to the plurality of peripheral electronic devices 400, respectively. For example, if a TV and a tablet PC are selected as peripheral electronic devices 400, it may be possible to send the found information of an image or video form to the TV and the found information of a text form to the tablet PC.

According to an embodiment, the control module 170 may select a device, which will receive the found information, from among the found peripheral electronic devices 400 and may control the control module 110 to send information (e.g., a media access control (MAC) address) about the selected device to the management server 300. Accordingly, the management server 300 may send the found information directly to the peripheral electronic device 400.

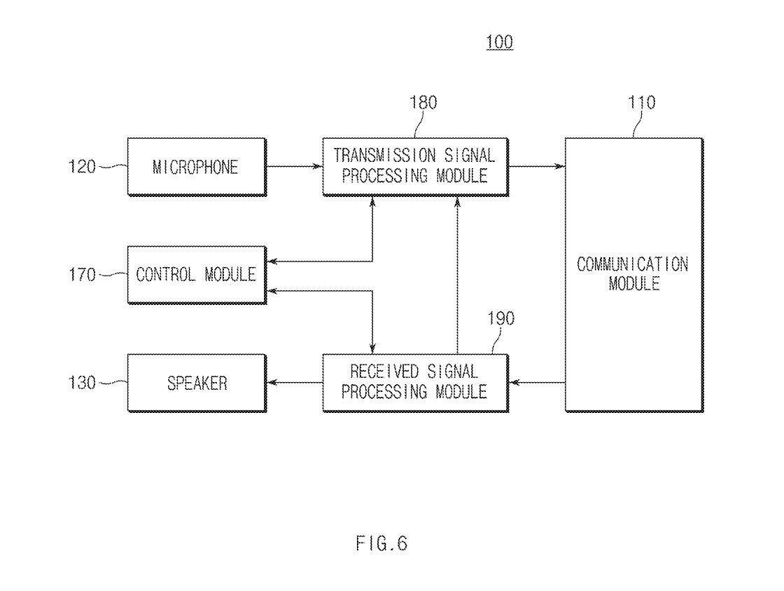

FIG. 6 is a block diagram illustrating a configuration of the first electronic device according to various embodiments of the present disclosure.

Referring to FIG. 6, the first electronic device 100 may include the communication module 110, the microphone 120, the speaker 130, a transmission signal processing module 170, or a received signal processing module 190. The first electronic device 100 illustrated in FIG. 6 may further include some of elements illustrated in FIG. 5. Since the communication module 110, the microphone 120, the speaker 130, and the control module 170 illustrated in FIG. 6 are described with reference to FIG. 5, a description thereof is omitted.

The transmission signal processing module 180 may process a voice signal of a user received from the microphone 120 and may send the processed signal to the communication module 110. According to an embodiment, the transmission signal processing module 180 may include an adaptive echo cancellation (AEC) module that cancels an echo signal received by an output device such as the speaker 130. According to an embodiment, if a signal processed by the received signal processing module 190 or a signal generated during a signal processing operation of the received signal processing module 190 is received, the AEC module may cancel an echo of the received signal and may provide the echo-free signal to the control module 170.

The received signal processing module 190 may correct a spectrum of an output value or signal, which is suitable for the output device (e.g., the speaker 130), by processing a voice signal of a counterpart received through the communication module 110. The voice signal of the counterpart processed by the received signal processing module 190 may be provided to the speaker 130. According to an embodiment, the received signal processing module 190 may provide the voice signal, which is processed or is generated during signal processing, to the transmission signal processing module 190.

The control module 170 may produce conversation content based on voice signals from the transmission signal processing module 180 and the received signal processing module 190. For example, the control module 170 may create conversation content of a voice form by aligning the voice signals from the transmission signal processing module 180 and the received signal processing module 190 in the order of times when the voice signals are received. As described above, the conversation content generated by the control module 170 may be sent to the management server 300 or the peripheral electronic device 400 through the control module 110.

An electronic device according to various embodiments of the present disclosure may include a communication module that sends conversation information between users of the electronic device and an external electronic device to a management server if the conversation is obtained and receives a keyword extracted using the conversation information from the management server, a control module that controls to search for information using the keyword and send a portion of the found information to the external electronic device, and a display that displays the found information.

According to an embodiment, the conversation information may include conversation content and participant identification information. According to an embodiment, the conversation content may include at least one of text data and/or voice data. According to an embodiment, the participant identification information may include at least one of a name, a phone number, an image, a service ID, and/or an e-mail address of each of users of the electronic device and the external electronic device.

According to an embodiment, the control module may search for information stored in at least one of a web server, a cloud server, and/or the electronic device based on the keyword.

According to an embodiment, the control module may send information, which is found from the web server, of the found information to the external electronic device.

According to an embodiment, the control module may determine whether the found information is public information or private information and select information to be sent to the external electronic device based on the determination.

According to an embodiment, the control module may convert a form of the found information into a form, in which the external electronic device receives information, based on a communication channel that the external electronic device uses.

According to an embodiment, the control module may display pieces of the public and private information of the found information on different areas of the display, respectively.

According to an embodiment, the control module may send at least a portion of the found information to at least one peripheral electronic device that exists within a range from the electronic device.

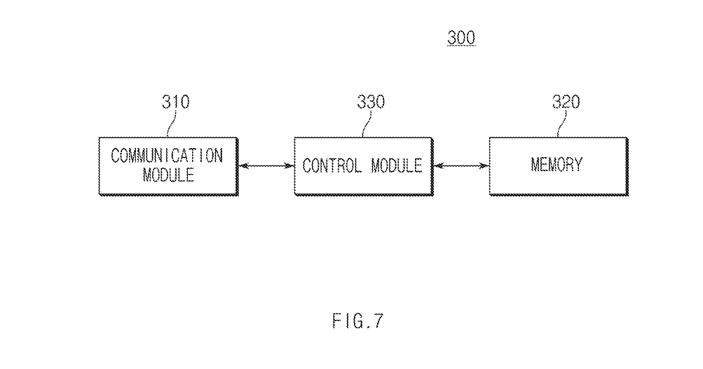

FIG. 7 is a block diagram illustrating a configuration of the management server according to various embodiments of the present disclosure.

Referring to FIG. 7, the management server 300 may include a communication module 310, a memory 320, or a control module 330.

The communication module 310 may be connected with the first electronic device 100 and the peripheral electronic device 400 over the network 10 so as to communicate with each other. For example, the communication module 310 may be connected with the first electronic device 100 and the peripheral electronic device 400 over an Internet network or mobile communication network.

According to an embodiment, the communication module 310 may receive conversation content between users of the first and second electronic devices 100 and 200 from the first electronic device 100 or the peripheral electronic device 400.

According to an embodiment, if a keyword is extracted by the control module 330 from conversation information that is received from the first electronic device 100 or the peripheral electronic device 400, the communication module 310 may send the extracted keyword to the first electronic device 100 or the peripheral electronic device 400.

According to an embodiment, if information associated with the keyword is found by the control module 330, the communication module 310 may send the found information to the first electronic device 100 or the peripheral electronic device 400.

The memory 320 may store information of a user that utilizes an information providing service according to an embodiment of the present disclosure. For example, the memory 320 may store conversation information of users of the first and second electronic devices 100 and 200. As another example, the memory 320 may store information that is found using the keyword extracted from the conversation content. According to an embodiment, the memory 320 may store information for each user that utilizes the information proving service.

The control module 330 may control each of the communication module 310 and the memory 320 to provide the found information to a user according to various embodiments of the prevent disclosure.

According to an embodiment, the control module 330 may process the conversation information to extract a keyword. According to an embodiment, if conversation content of a voice form is received, the control module 330 may convert the conversation content from the voice form into a text form and may extract a keyword from the conversation content of the text form. According to an embodiment, the control module 330 may grasp intention of a user by analyzing the conversation content. According to an embodiment, to extract a keyword or grasp the intention of the user, the control module 330 may use past conversation history between a counterpart and a user stored in the memory 320.

According to an embodiment, the control module 330 may search for keyword-related information based on the keyword. According to an embodiment, the control module 330 may search for the keyword-related information from at least one of a web server (not shown) and/or a cloud server (not shown) that a user of the first electronic device 100 utilizes. In the case where the control module 330 needs rights to access the web server or cloud server, the control module 330 may request necessary information (e.g., an account ID and a password) from the first electronic device 100 and may receive the necessary information therefrom.

According to an embodiment, the control module 330 may classify the found information and may grant the priority to the classified found information. According to an embodiment, the control module 330 may remove duplicated information of the found information and may classify the information as the same or similar information based on a specific criterion. According to an embodiment, the priority of the found information may be determined according to a specific criterion such as importance, similarity, and the like. For example, the control module 330 may determine the priority based on a degree of relevance of a found page to the keyword, a degree of relevance of a found page to query intention, a degree of relevance about user/counterpart query, and the like.

According to an embodiment, the control module 330 may identify a user based on received conversation information. According to an embodiment, the control module 330 may identify a user based on a counterpart image. As another example, the control module 330 may identify a user based on voice conversation information. According to an embodiment, if a user is identified, the control module 330 may use information (e.g., past conversation history or past found information) of the user stored in the memory 320 when extracting a keyword, grasping his/her intention, or searching for keyword-related information.

According to an embodiment, if an instruction for designating the peripheral electronic device 400 as a device that will receive the found information is received from the first electronic device 100, the control module 330 may send the found information to the peripheral electronic device 400.

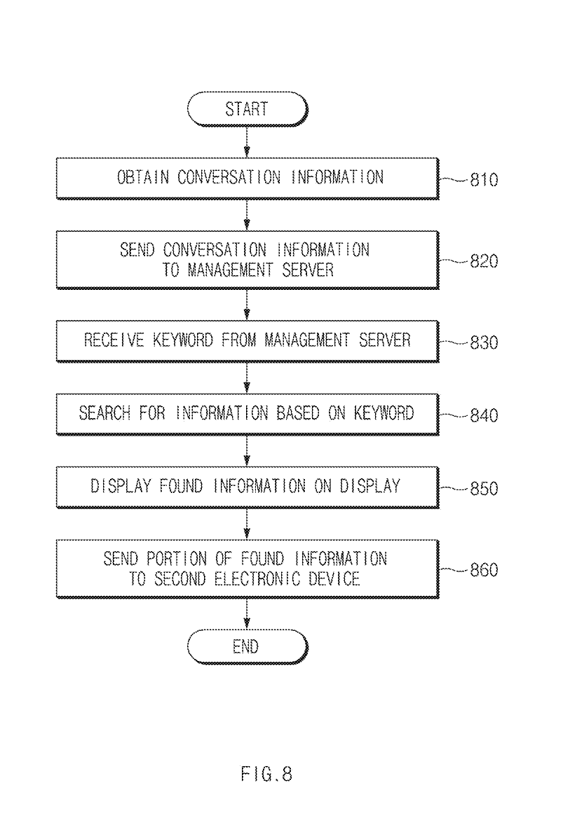

FIG. 8 is a flowchart illustrating an information providing method of the first electronic device according to various embodiments of the present disclosure. The flowchart illustrated in FIG. 8 may include operations processed in the electronic device 100 shown in FIG. 1. Even though omitted below, details about the electronic device 100 described with reference to FIGS. 1 to 6 may be applied to the flowchart illustrated in FIG. 8.

Referring to FIG. 8, in operation 810, the first electronic device 100 may obtain conversation information. According to an embodiment, the conversation information may include conversation content between the users of the first electronic device 100 and the second electronic device 200. The first electronic device 100 may generate conversation content based on a voice or text input by a user and a voice or text of a conversation counterpart received from the second electronic device 200. According to an embodiment, the conversation information may include conversation content and participant identification information. The participant identification information that is information for identifying the users of the first electronic device 100 and the second electronic device 200 may include, for example, at least one of a phone number, an image, a service ID (e.g., a messaging application ID or an SNS ID), and/or an e-mail address. According to an embodiment, the first electronic device 100 and the second electronic device 200 may share the participant identification information with each other.

In operation 820, the first electronic device 100 may send the conversation information to the management server 300.

In operation 830, the first electronic device 100 may receive a keyword, which is found based on the conversation information, from the management server 300. According to an embodiment, the keyword received from the management server 300 may be of a text form.

In operation 840, the first electronic device 100 may search for keyword-related information based on the keyword received from the management server 300 or the peripheral electronic device 400. According to an embodiment, the first electronic device 100 may search for the keyword-related information from at least one of a web server (not shown) and/or a cloud server (not shown) that a user utilizes. Although not illustrated in FIG. 8, the first electronic device 100 may receive the found information from the management server 300. According to an embodiment, the found information that is received from the management server 300 may be information that is found from a web server (not shown) or a cloud server (not shown) that a user utilizes.

In operation 850, the first electronic device 100 may display the found information on the display 160. According to an embodiment, the first electronic device 100 may select information, which is to be displayed on the display 160, of the found information and may display only the selected information on the display 160.

According to an embodiment, the first electronic device 100 may determine whether the found information (e.g., information that a user of the first electronic device 100 searches for or found information received from the management server 300) is public information or private information. According to an embodiment, the first electronic device 100 may determine whether the found information is public information or private information, based on a source of the found information. According to an embodiment, the first electronic device 100 may determine whether the found information is public information or private information, based on rights to access the found information. According to an embodiment, the first electronic device 100 may determine whether the found information is public information or private information, based on a kind of the found information.

According to an embodiment, the first electronic device 100 may display pieces of public and private information of the found information in different areas of the display 160, respectively. According to an embodiment, the first electronic device 100 may display information found from the first electronic device (e.g., a memory) or cloud server and information found from a web server on different areas of the display 160, respectively.

In operation 860, the first electronic device 100 may send a portion of the found information to the second electronic device 200. According to an embodiment, the first electronic device 100 may determine whether the found information is public information or private information and may send the public information of the found information to the second electronic device 200 based on the determination result. According to an embodiment, information, which is found from a web server, of the found information may be sent to the second electronic device 200. According to an embodiment, the first electronic device 100 may determine whether information that is found using identification information of a user of the second electronic device 200 is information associated with the user of the second electronic device 200 and may send information, which is associated with the user of the second electronic device 200, of the found information to the second electronic device 200 based on the determination result.

According to an embodiment, the first electronic device 100 may search for peripheral electronic devices that exist within a specific range. According to an embodiment, the first electronic device 100 may select at least one of the found peripheral electronic devices 400. According to an embodiment, the first electronic device 100 may receive device profiles from the found peripheral electronic devices 400 and may select at least one of the found peripheral electronic devices 400 based on the device profiles. The device profile may include, for example, identification information, a location, owner information, input/output sources, and the like of the peripheral electronic device 400. According to an embodiment, the first electronic device 100 may send the found information to the peripheral electronic device 400. According to an embodiment, if a plurality of peripheral electronic devices 400 are selected, the first electronic device 100 may send pieces of different found information to the plurality of peripheral electronic devices 400, respectively. According to an embodiment, if a plurality of peripheral electronic devices 400 are selected, the first electronic device 100 may send pieces of found information of different forms to the plurality of peripheral electronic devices 400, respectively.

According to an embodiment, the first electronic device 100 may select a device, which will receive the found information, from among the found peripheral electronic devices 400 and may send information (e.g., a MAC address) about the selected device to the management server 300. Accordingly, the management server 300 may send the found information directly to the peripheral electronic device 400.

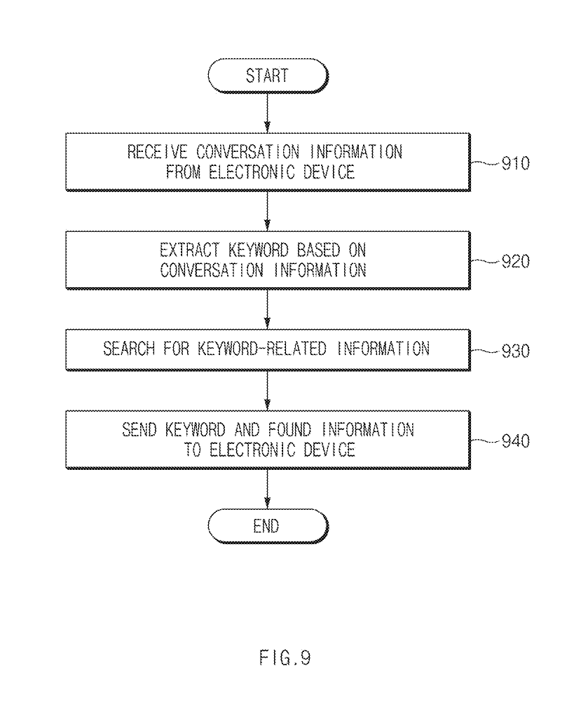

FIG. 9 is a flowchart illustrating an information providing method of the management server according to various embodiments of the present disclosure. A flowchart illustrated in FIG. 8 may include operations that the management server 300 illustrated in FIG. 7 processes. Thus, even though omitted below, a description about the first electronic device 100 given with reference to FIG. 7 may be applied to the flowchart shown in FIG. 9.

Referring to FIG. 9, in operation 910, the management server 300 may receive conversation content between users of the first and second electronic devices 100 and 200 from the first electronic device 100 or the peripheral electronic device 400.

According to an embodiment, in operation 920, the management server 300 may extract a keyword based on the conversation information. For example, if conversation content of a voice form is received, the management server 300 may convert the conversation content from the voice form into a text form and may extract a keyword from the conversation content of the text form. According to an embodiment, the management server 300 may grasp intention of a user based on the analysis result. According to an embodiment, to extract a keyword or grasp the intention of the user, the management server 300 may use past conversation history between a counterpart and a user stored in the memory 320.

According to an embodiment, in operation 930, the management server 300 may search for keyword-related information based on the keyword. According to an embodiment, the management server 300 may search for the keyword-related information from at least one of a web server (not shown) and/or a cloud server (not shown) that a user utilizes. In the case where the management server 300 needs rights to access the web server or cloud server, the management server 300 may request necessary information (e.g., an account ID and a password) from the first electronic device 100 and may receive the necessary information therefrom.

According to an embodiment, the management server 300 may classify the found information and may grant the priority to the classified found information. According to an embodiment, the management server 300 may remove duplicated information of the found information and may classify the information as the same or similar information based on a specific criteria. According to an embodiment, the priority of the found information may be determined according to a specific criteria such as importance, similarity, and the like. For example, the management server 300 may determine the priority based on a degree of relevance of a found page to the keyword, a degree of relevance of a found page to query intention, a degree of relevance about user/counterpart query, and the like.

According to an embodiment, the management server 300 may identify a user based on received conversation information. For example, the management server 300 may identify a user based on a counterpart image. As another example, the management server 300 may identify a user based on voice conversation information. According to an embodiment, if a user is identified, the management server 300 may use information (e.g., past conversation history or past found information) of the user stored in the memory 320 when extracting a keyword, grasping his/her intention, or searching for keyword-related information.

According to an embodiment, in operation 940, the management server 300 may send the extracted keyword and the found keyword-related information to the first and electronic device 100 or the peripheral electronic device 400.

An information providing method of an electronic device according to various embodiments of the present disclosure may include obtaining conversation information between users of the electronic device and an external electronic device, sending the conversation information to a management server, receiving a keyword, which is extracted based on the conversation information, from the management server, searching for information based on the keyword, displaying the found information on a display, and sending a portion of the found information to the external electronic device.

According to an embodiment, the conversation information may include conversation content and participant identification information. According to an embodiment, the conversation content may include at least one of text data and/or voice data. According to an embodiment, the participant identification information may include at least one of a name, a phone number, an image, a service ID, and/or an e-mail address of each of users of the electronic device and the external electronic device.

According to an embodiment, the searching may include searching for information stored in at least one of a web server, a cloud server, and the electronic device based on the keyword.

According to an embodiment, the sending of the portion of the found information may include sending information, which is found from a web server, of the found information to the external electronic device.

According to an embodiment, the sending of the portion of the found information may include determining whether the found information is public information or private information, and selecting information to be sent to the external electronic device based on the determination.

According to an embodiment, the sending of the portion of the found information may include converting a form of a portion of the found information into a form, in which the external electronic device receives information, based on a communication channel that the external electronic device uses.

According to an embodiment, the displaying may include determining whether the found information is public information or private information, displaying the public information of the found information on a first area of the display, and displaying the private information of the found information on a second area of the display.

According to an embodiment, the method may further include sending at least a portion of the found information to at least one peripheral electronic device that is placed within a range from the electronic device.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments of the present disclosure may be, for example, implemented by instructions stored in a computer-readable storage media in the form of a program module. If the instructions are executed by a processor (e.g., a control module 170), the one or more processors may perform functions corresponding to the instructions. The computer-readable storage media, for example, may be the memory 150.

A computer-readable recording medium may include a hard disk, a floppy disk, a magnetic media (e.g., a magnetic tape), an optical media (e.g., a compact disc read only memory (CD-ROM), a DVD, or a magneto-optical media (e.g., a floptical disk)), and a hardware device (e.g., a ROM, a random access memory (RAM), or a flash memory). Also, a program instruction may include not only a mechanical code such as things generated by a compiler but also a high-level language code executable on a computer using an interpreter. The above-mentioned hardware device may be configured to operate as one or more software modules to perform operations according to various embodiments of the present disclosure, and vice versa.

Modules or program modules according to various embodiments of the present disclosure may include at least one or more of the above-mentioned components, some of the above-mentioned components may be omitted, or other additional components may be further included therein. Operations executed by modules, program modules, or other elements may be executed by a successive method, a parallel method, a repeated method, or a heuristic method. Also, some of operations may be executed in different sequences, omitted, or other operations may be added.

According to various embodiments of the prevent disclosure, a user of an electronic device may be provided with information associated with content of conversation with a specific counterpart in real time. Furthermore, if an electronic device more suitable for providing information is located around the user, the user may be provided with the information associated with the conversation content through the electronic device located around the user.

According to various embodiments of the prevent disclosure, the user of the electronic device may provide the information associated with the conversation content to a conversation counterpart and may protect private information of the user by limiting information to be sent to the counterpart based on information characteristics.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a communication module;
a display; and
a processor configured to:
obtain conversation information between users of the electronic device and an external electronic device,
send the conversation information to a management server,
receive a keyword, which is extracted based on the conversation information, from the management server, search for information based on the keyword,
display the found information on the display, and
send a portion of the found information to the external electronic device.

2. The electronic device of claim 1, wherein the conversation information comprises conversation content and participant identification information.

3. The electronic device of claim 2, wherein the conversation content comprises at least one of text data and voice data.

4. The electronic device of claim 2, wherein the participant identification information comprises at least one of a name, a phone number, an image, a service identifier, and an e-mail address of each of users of the electronic device and the external electronic device.

5. The electronic device of claim 1, wherein the processor is configured to search for information stored in at least one of a web server, a cloud server, and the electronic device based on the keyword.

6. The electronic device of claim 5, wherein the processor is configured to send information, which is found from the web server, of the found information to the electronic device.

7. The electronic device of claim 1, wherein the processor is configured to:
determine whether the found information is public information or private information, and
select information to be sent to the external electronic device based on the determination.

8. The electronic device of claim 1, wherein the processor is configured to convert a form of the found information into a form, in which the external electronic device receives information, based on a communication channel that the external electronic device uses.

9. The electronic device of claim 1, wherein the processor is configured to:
determine whether the found information is public information or private information, and
display pieces of the public and private information of the found information on different areas of the display, respectively.

10. The electronic device of claim 1, wherein the processor is configured to send at least a portion of the found information to at least one peripheral electronic device that exists within a range from the electronic device.

11. A method of providing information in an electronic device, the method comprising:
obtaining conversation information between users of the electronic device and an external electronic device;
sending the conversation information to a management server;
receiving a keyword, which is extracted based on the conversation information, from the management server;
searching for information based on the keyword;
displaying the found information on a display; and
sending a portion of the found information to the external electronic device.

12. The method of claim 11, wherein the conversation information comprises conversation content and participant identification information.

13. The method of claim 12, wherein the conversation content comprises at least one of text data and voice data.

14. The method of claim 12, wherein the participant identification information comprises at least one of a name, a phone number, an image, a service identifier, and an e-mail address of each of users of the electronic device and the external electronic device.

15. The method of claim 11, wherein the searching comprises:
searching for information stored in at least one of a web server, a cloud server, and the electronic device based on the keyword.

16. The method of claim 11, wherein the sending of the portion of the found information comprises:
sending information, which is found from a web server, of the found information to the external electronic device.

17. The method of claim 11, wherein the sending of the portion of the found information comprises:
determining whether the found information is public information or private information; and
selecting information to be sent to the external electronic device based on the determination.

18. The method of claim 11, wherein the sending of the portion of the found information comprises:
converting a form of a portion of the found information into a form, in which the external electronic device receives information, based on a communication channel that the external electronic device uses.

19. The method of claim 11, wherein the displaying comprises:
determining whether the found information is public information or private information;
displaying the public information of the found information on a first area of the display; and
displaying the private information of the found information on a second area of the display.

20. A non-transitory computer-readable storage medium storing instructions that, when executed, cause at least one processor to perform a method, the method comprising:
obtaining conversation information between users of the electronic device and an external electronic device;
sending the conversation information to a management server;
receiving a keyword, which is extracted based on the conversation information, from the management server;
searching for information based on the keyword;
displaying the found information on a display; and
sending a portion of the found information to the external electronic device.
